(19) United States
(12) Patent Application Publication
(10) Pub. No.: US 2026/0269148 A1
(43) Pub. Date: Sep. 10, 2026

(54) CIRCUIT BREAKER OPERATION SAFETY LOCKOUT DEVICE

(71) Applicant: ABB Schweiz AG, Baden (CH)

(72) Inventors: Ryan Sparrow, West Hartford, CT (US); James Lawrence Rosen, West Hartford, CT (US)

(21) Appl. No.: 19/070,022

(22) Filed: Mar. 4, 2025

(51) Int. Cl. H01H 9/22; H01H 9/28

(52) U.S. Cl. CPC H01H 9/22; H01H 9/28

(57) ABSTRACT

The present disclosure relates to a circuit breaker with a lockout tab, and a method of operation thereof. The circuit breaker comprises a housing with a handle and a lockout tab positioned partially therein. The handle is movable between a disengaged position and an engaged position. The lockout tab is movable between a retracted position and an extended position. The lockout tab is positioned such that the handle contacts the lockout tab while moving between the disengaged position and the engaged position. A locking member may be installed through the lockout tab while in the extended position. If the locking member is installed, the movement of the handle to the engaged position is impeded. Removal of the lockout device allows the handle to be moved to the engaged position, which results in the movement of the lockout tab to the retracted position.

### TECHNICAL FIELD

The present disclosure generally relates to a circuit breaker. In particular, the present disclosure relates to circuit breakers with a lockout tab for preventing operation of the circuit breaker, and methods for preventing operation of the circuit breaker when the lockout tab is in use.

### BACKGROUND

A circuit breaker is a resettable device for protecting an electrical circuit from damage resulting from excess electrical current. Most circuit breakers include a contact mechanism, which includes a stationary group of electrical contacts and a movable group of electrical contacts. The movable group of electrical contacts is movable between an open position where the supply of electricity is disabled by the circuit breaker and a closed position where the supply of electricity is enabled by the circuit breaker. The circuit breaker additionally includes a handle such as a rocker switch, lever, or similar device, which is connected via a mechanical system or linkage to the movable group of electrical contacts to move the electrical contacts between the open and closed positions.

Most circuit breakers additionally include mechanisms for forcing the movable contacts to the open position when excess electrical current is detected. Frequently, the mechanism is actuated using an electromagnet which is in turn charged using the current passing through the circuit breaker. An increase in the magnitude of the current passing through the circuit breaker causes the magnetic field associated with the electromagnet to also increase. When the current passing through the circuit breaker reaches a threshold magnitude, the associated magnetic field engages a paddle which causes the mechanism to move the movable group of electrical contacts to the open position, thereby disabling the supply of electric current through the circuit breaker. Additionally, a circuit breaker may include a bimetal element connected to the circuit which bends under increased operating current. The bimetal element may bend into contact with the paddle for triggering the mechanism for moving the movable group of electrical contacts to the open position. A circuit breaker operator can then manually move the handle to an engaged position which actuates the mechanical linkage to move the movable group of electrical contacts back to the closed position, thus closing the circuit and enabling the return of current flow through the circuit breaker.

In some instances, a circuit breaker may act as a common opening mechanism for each phase of a multi-phase circuits-these circuit breakers are often referred to as multi-pole circuit breakers. In multi-phase alternating current circuits, each phase of the circuit comprising the multi-pole circuit breaker will typically have separate, dedicated groups of stationary and movable electrical contacts. Multi-pole circuit breakers may have either a single handle to collectively control each group of movable electrical contacts, or a group of physically linked handles where each group of movable electrical contacts has a handle which is linked to the neighboring handle. Each distinct handle is linked to ensure common opening and closing of each pole. Typically, multi-pole circuit breakers are designed for use with two or three phases.

Circuit breaker contacts are opened prior to performing maintenance or repairs on the electrical system. The handle is moved to the disengaged position to open the circuit and enable a technician to safely complete the required system maintenance. Locking the circuit breaker in the disengaged/open position may be desirable to ensure that the circuit is not unintentionally closed (e.g. by another technician or by unintended contact with the circuit breaker) while the technician is performing maintenance, thereby protecting the technician from potential shock resulting from a suddenly active circuit. Locking the circuit breaker in the open position to negate the flow of current in a maintenance scenario may be known as a lockout.

The circuit breaker is often locked using an externally mounted lockout device. Such lockout devices are located externally along the breaker housing and physically restrict the breaker handle from moving the contacts to the closed positions. Externally mounted lockout devices also exist which restrict the contacts from moving to the open position. Existing discrete lockout devices are sometimes manufactured by the breaker manufacturer or a third party, and may be installed or retrofitted in the field. Discrete retrofit devices are time consuming for technicians to install, and may be costly depending on the number of circuit breakers. Alternatively, lockout devices may be installed at the factory. Irrespective of the installation process, the lockout devices also require additional installation space proximate the breaker to accommodate their combination with the circuit breaker. The circuit breakers may be located in housings with limited space within the housing making their installation difficult and often preventing the lockout device from being successfully installed. If the lockout device is successfully installed, due to limited space around the breaker, it may be difficult to access the lockout device to unlock the device.

Accordingly, there exists a need to integrate a lockout device with the circuit breaker to reduce time and cost of installation, and the cost of the circuit breaker per se. Furthermore, there exists a need to reduce the amount of space required for a circuit breaker installation.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### BRIEF DESCRIPTION

In one aspect, a circuit breaker is disclosed. The circuit breaker includes a housing; a handle, wherein the handle is movable between a first position and a second position; and a lockout tab integral with the circuit breaker and supported by the housing, the lockout tab moveable between a retracted position and an extended position. The lockout tab includes a body including a first end and a second end, and a receiver opening formed in the body proximate the first end and configured to receive a device for impeding the movement of the tab to the retracted position, wherein the first end is located outside the housing and the second end is located inside the housing, the body further comprising an abutment surface formed in the body located proximate the second end and in a path of motion of the handle between the first position and the second position. When the handle is moved into abutment with the abutment surface the lockout tab may be pushed to the retracted position by the handle. When the handle is moved into abutment with the abutment surface and a motion impeding device is installed, movement of the tab to the retracted position is impeded and movement of the handle to the second position is impeded.

In another aspect, a circuit breaker is disclosed. The circuit breaker includes a housing defining a housing chamber, a handle configured to be located partially within the housing, wherein the handle comprises a body with a first end. The handle body is moveable within the housing chamber. The circuit breaker further includes a lockout tab which includes a lockout tab body movable within the housing between a retracted position and an extended position. The lockout tab further includes an abutment surface, wherein the lockout tab is moved to the retracted position when the first end of the handle body is moved into abutment with the abutment surface.

In another aspect, a method of locking a circuit breaker is disclosed. The circuit breaker includes a housing; a handle partially enclosed within the housing, the handle movable between a first position and a second position; and an integral lockout tab positioned partially within the housing, the lockout tab comprising an abutment surface positioned in a path of motion of the handle. The method includes extracting, from a housing of the circuit breaker, the lockout tab, wherein the lockout tab comprises a body with a receiver opening, and inserting a locking member through the receiver opening.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of a circuit breaker with a lockout tab of the present disclosure.

FIG. 2A is an isometric view of the lockout tab of FIG. 1.

FIG. 2B is a front view of the lockout tab of FIG. 2A.

FIG. 2C is a sectional view of the lockout tab taken along section line 2C-2C in FIG. 2B.

FIG. 3A is an isometric view of the handle of the circuit breaker of FIG. 1.

FIG. 3B is a side view of the handle of FIG. 3A.

FIG. 4 is a sectional view of the circuit breaker taken along section line 4-4 of FIG. 1.

FIG. 5 is an internal perspective view of the circuit breaker with the lockout tab in an extended position and the handle located away from the lockout tab.

FIG. 6 is an internal perspective view of the circuit breaker of FIG. 5 with the lockout tab in the extended position and the end of the handle in abutment with the extended lockout tab.

FIG. 7 is an internal perspective view of the circuit breaker of FIG. 5 with the lockout tab in a retracted position and the end of the handle passing through an opening in the lockout tab.

FIG. 8 is an internal perspective view of the circuit breaker of FIG. 5 with the lockout tab in the retracted position and the handle located away from the retracted lockout tab.

FIG. 9 is an internal perspective view of the circuit breaker of FIG. 5 with a locking member inserted through the lockout tab and the handle in abutment with the lockout tab, impeding further movement of the lockout tab and handle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

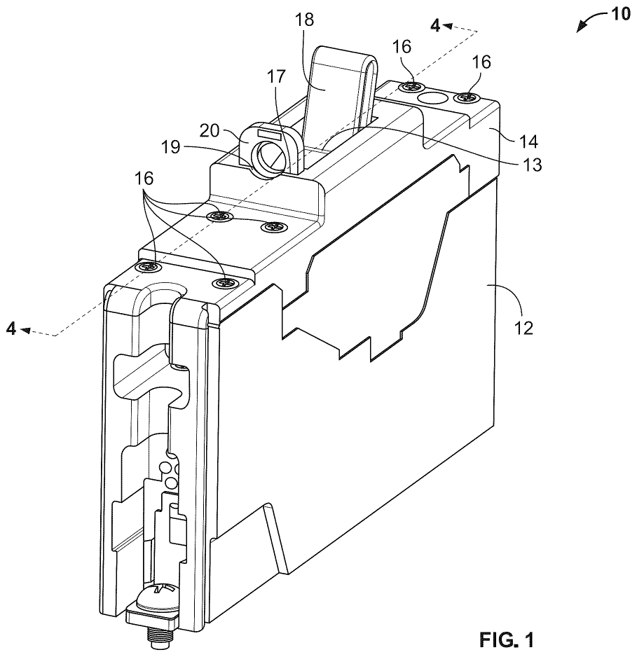

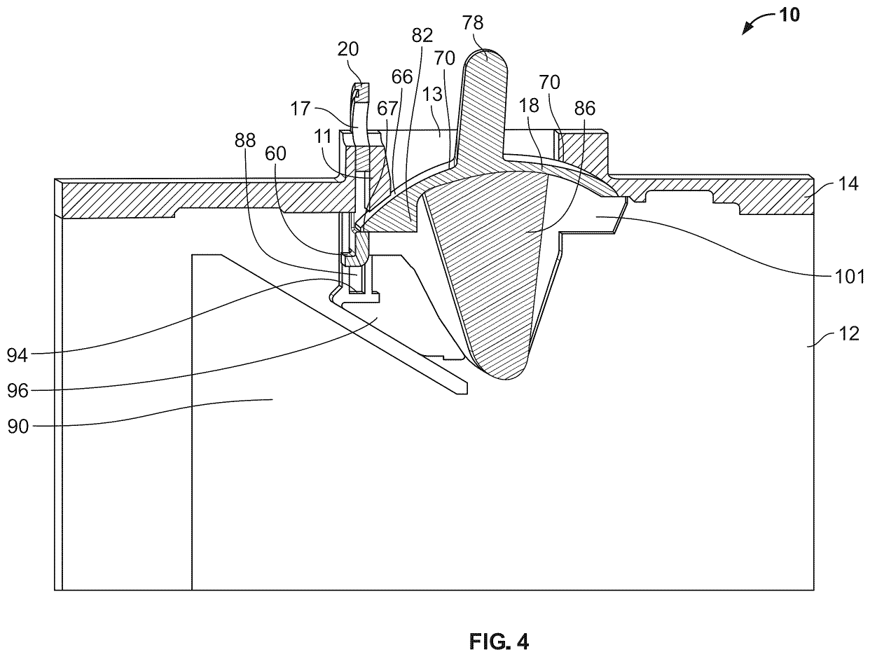

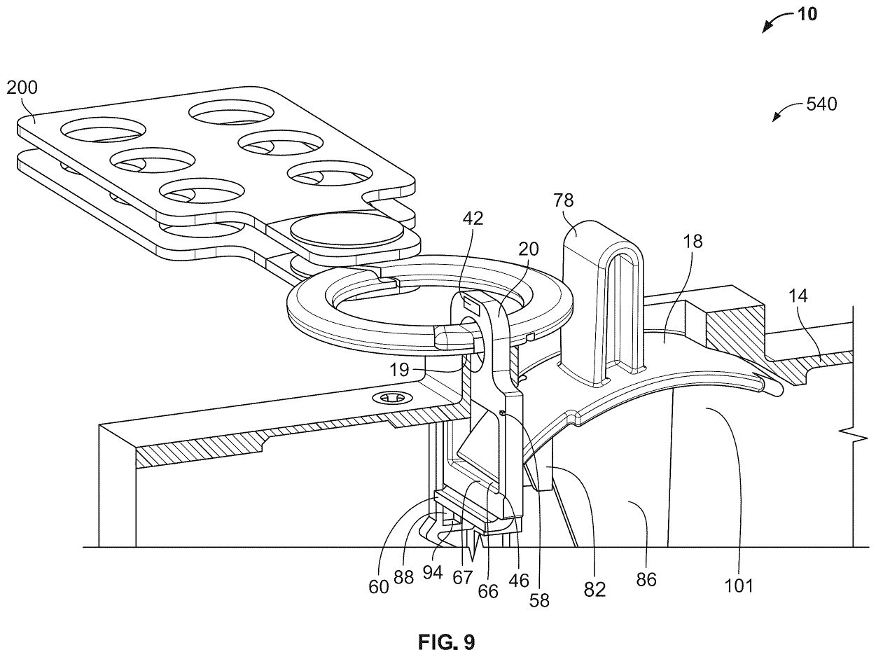

A single pole circuit breaker 10 that includes an integral retractable lockout tab 20, is shown in FIG. 1. The circuit breaker 10 includes a housing 12 which defines a housing chamber 101 shown in FIG. 4. A top plate 14 is removably attached to the housing 12 with a number of fasteners 16. A first slot 13 is formed in the top plate 14 and permits the handle 18 to extend through the slot 13 outwardly from the housing chamber and to be moved within the first slot 13 by a technician or other user between open/disengaged and closed/engaged positions. A second slot 17 is formed in the top plate 14 adjacent one end of the first slot 13. A rib 11 forms a wall of second slot 17, and prevents out-of-plane movement of the tab between the slot walls, and more specifically prevents undesirable side-to-side tab movement or bending when the tab is in the extended position of FIG. 4. As shown in FIG. 1, a notch 19 is formed in top plate 14. The notch, in combination with an opening 40 in the lockout tab 20 support a locking member 200 when the locking member 200 is inserted in the extended lockout tab as shown in FIG. 9. The notch 19 may have an arcuate configuration.

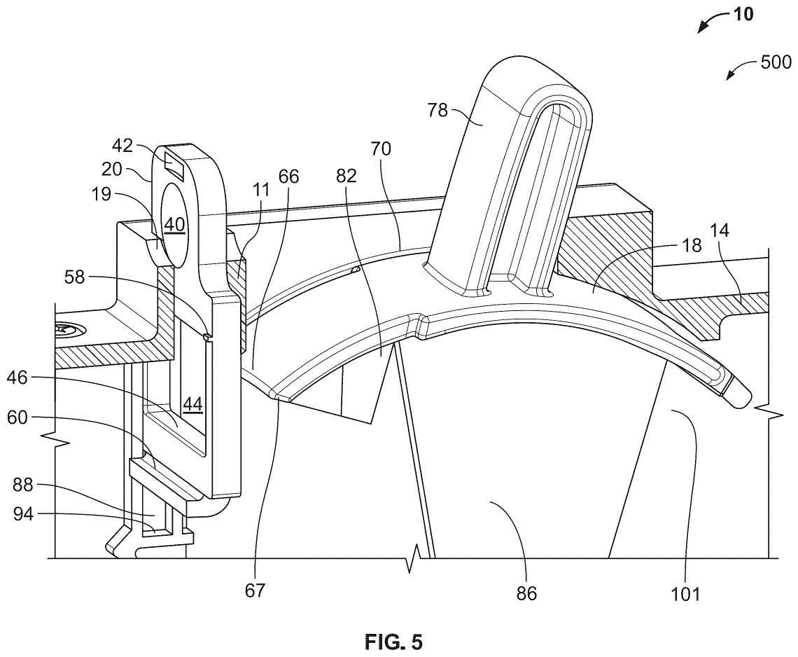

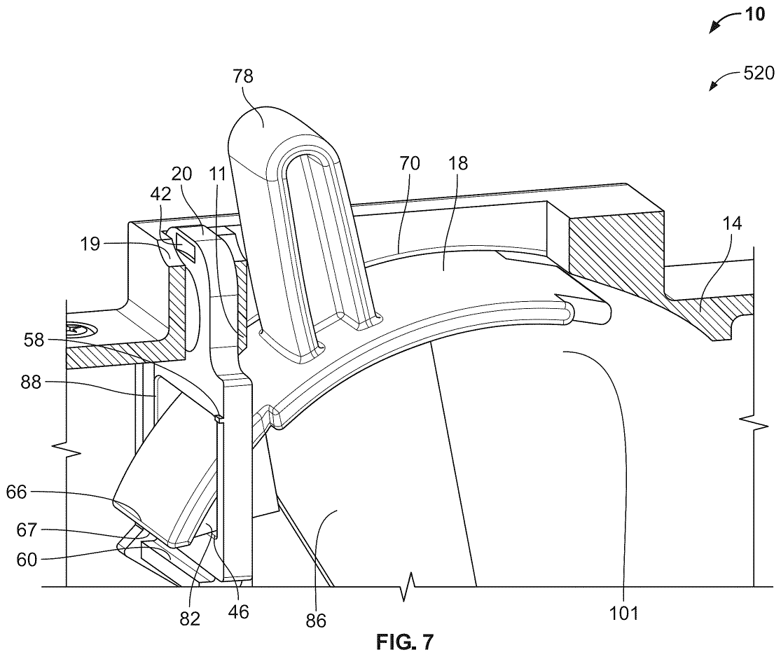

The handle 18 is positioned within the internal volume 101 and partially protrudes through the first slot 13. The handle 18 is movable within the first slot 13 between the opposed ends of the slot 13 that serves to open and close the circuit breaker 10. The lockout tab 20 is also partially positioned in the internal volume 101 when the tab 20 is located in the second slot 17, and partially protrudes from the top plate 14 through the second slot 17. The lockout tab 20 is movable in the second slot 17 toward and away from the top plate 14 between an extended position and a retracted position shown respectively in FIG. 5 and FIG. 7.

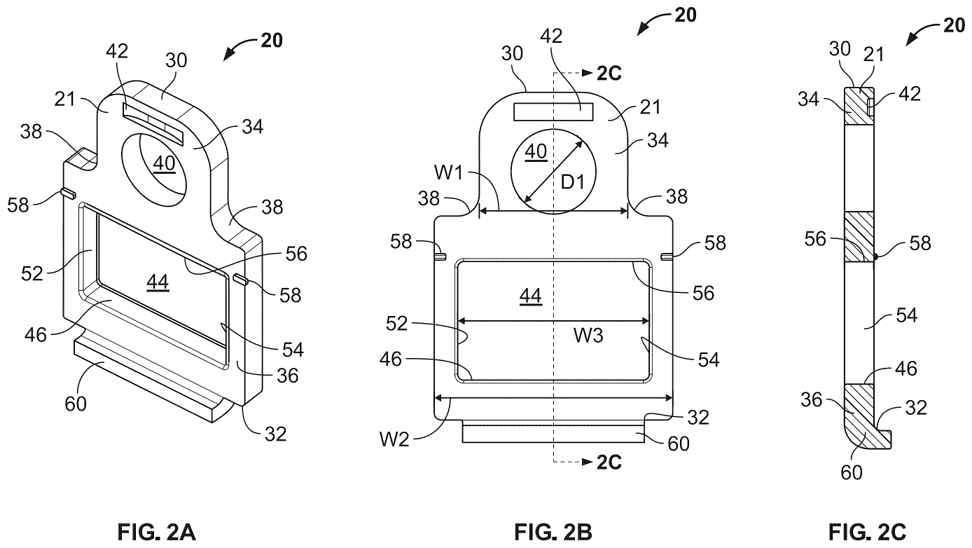

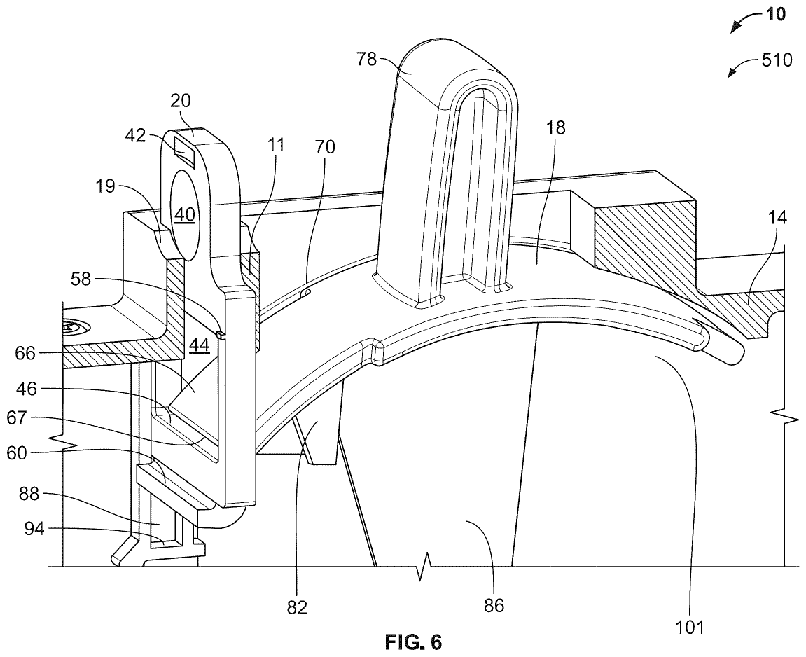

A series of detailed views of the discrete lockout tab 20 are shown in FIGS. 2A-2C Referring now to FIG. 2A, the lockout tab 20 may comprise a unitary body 21. The body 21 comprises a substantially constant thickness and includes opposed first end 30 and second end 32. The unitary body 21 of the lockout tab 20 includes a first section 34 terminating in first end 30 and a second section 36 terminating in second end 32. The first section 34 and second section 36 are joined at shoulders 38. The magnitude of the lateral width W1 of the first section 34 is less than the magnitude of the lateral width W2 of the second section 36. Furthermore, lateral width W2 is greater than a width of the second slot 17, while lateral width W1 is less than the width of the second slot 17. Shoulders 38 have a variable width defined by an arcuate profile between the first section 34 and second section 36. Each of the first section 34 and second section 36 are substantially rectangular in shape. As shown in FIG. 6, when the lockout tab is located in the second slot 17, the first section 34 protrudes from the top plate 14 and the second section 36 of the lockout tab 20 is located in the housing chamber 101.

The lockout tab 20 includes a receiver opening 40 which is positioned in the first section 34 and disposed through the thickness 23. The receiver opening 40 is positioned proximate the first end 30 and the shoulders 38. The receiver opening 40 may be largely circular with a diameter D1, as shown. However, the receiver opening 40 may be any configuration that is suitably configured to receive locking member 200. In some embodiments, the receiver opening is sized to receive the locking member 200 as shown in FIG. 9. In some embodiments, the locking member 200 is a padlock. In some embodiments, the locking member 200 is a hasp, such as a team lockout hasp as shown in FIG. 9. In some embodiments, the locking member is a safety seal wire. Those skilled in the art will appreciate that other known locking members may be used without departing from the scope of the disclosure. Generally, in the present embodiment it may be desirable for locking member 200 to have a thickness or diameter greater than an eighth of an inch. However, those skilled in the art will appreciate that reducing the size of the receiver opening 40 will also reduce the minimum required thickness without departing from the scope of the disclosure. The locking member 200 extends through the receiver opening and is supported on notch 19. A laterally extending groove 42 may be provided in the first section proximate the first end 30. As shown in FIG. 2B, the groove is located between the receiver opening 40 and the first end 30, and extends a distance into the thickness of the first section 34. As shown in FIG. 2C, the groove 42 is provided on one side of the unitary body 21. In some embodiments, the groove 42 may be present on both sides of the unitary body 21. In some embodiments, the groove defines an arcuate profile, as best shown in FIG. 2A. In some embodiments, the groove is sized to receive a fingernail or another object that may be located in the groove 42 to enable the tab 20 to be moved from the retracted position to the extended position.

As shown in FIGS. 2A, 2B and 2C, the second section 36 includes a handle opening 44 located between the shoulders 38 and the second end 32. The handle opening extends through the second section 36. The handle opening 44 may be substantially rectangular, but the handle opening 44 may comprise any configuration that enables the switch 18 to pass therethrough as will be described herein. The handle opening 44 is defined by upper surface 56, abutment surface 46, and first and second lateral surfaces 52 and 54 that extend between the top and abutment surfaces 56 and 46. As shown in FIG. 2A the abutment surface 46 is the side of the handle opening 44 nearest the second end 32. In the present embodiment, the handle opening 44 comprises a lateral width W1. The handle opening 44 may be positioned substantially at a center of the second section 36.

In some embodiments, detents 58 are formed in the second section 36 proximate shoulders 38. As shown in FIG. 2C each detent 58 protrudes slightly from the unitary body 21. As shown, the unitary body 21 includes two detents 58, but those skilled in the art will appreciate that other numbers of detents may be used without departing from the scope of the disclosure. In some embodiments, the body 21 comprises a shelf 60 that extends outwardly from the second section 36 proximate the second end 32. The shelf 60 increases the stiffness and structural stability of lockout tab 20, thus reducing the tendency of the lockout tab 20 to deflect or buckle when the lockout tab undergoes compression loads. In some embodiments, the lockout tab 20 may be designed to withstand at least 50 lbs of unlocking force.

It may be desirable to form the lockout tab 20 out of a plastic polymer. For example, the lockout tab 20 may be made from a polyamide such as nylon 66. In some embodiments, the lockout tab 20 may be manufactured using an injection molding process. In some alternative embodiments, the lockout tab 20 may be manufactured using a molding process such as injection molding or an additive manufacturing process such as 3D printing. The lockout tab 20 may alternatively be formed out of a metal, such as aluminum or steel, as long as the metal of choice is electrically insulated either naturally or via a coating. The coating may be a thermoplastic coating such as nylon. The lockout tab 20 may be manufactured using a casting process, a subtractive manufacturing process such as CNC milling, or a stamping process. The coating may be applied after a work piece of the lockout tab 20 is manufactured. Those skilled in the art will appreciate that other materials and/or manufacturing processes may be suitable for the lockout tab 20 without departing from the scope of the present disclosure.

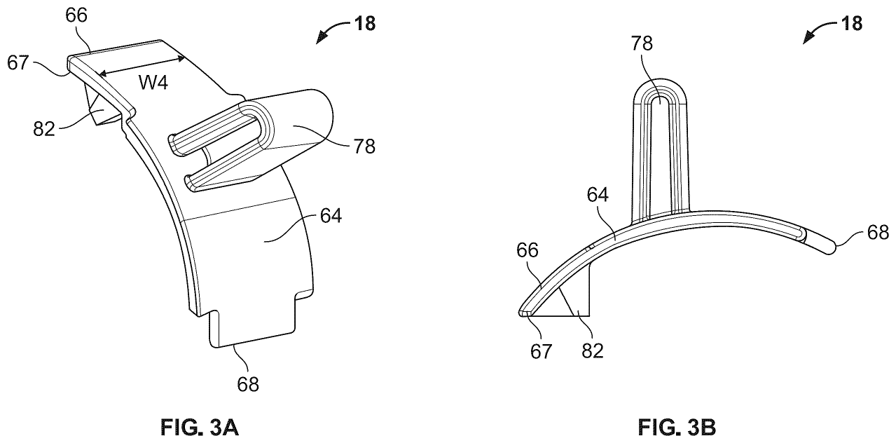

A series of detailed views of the handle 18 are shown in FIGS. 3A and 3B. The handle 18 is a unitary member and comprises an arcuate-shaped body 64 and a grip 78 that is located along the body 64 and extends outwardly from the body. During use, the body 64 is located in the housing chamber 101 and the grip 78 protrudes from the first slot 13 and is moveable between the ends of the slot. A conventional mechanism or actuator (e.g. a mechanical linkage 86) well known to those skilled in the related art enables the desired movement of the handle 18 to thereby move the grip between the slot ends and open and close the circuit associated with circuit breaker 10. The body 64 comprises an abutment end 66 and a rounded end 68 opposite the abutment end. The abutment end 66 defines a substantially planar surface 67 which is configured to contact the abutment surface 46 of opening 44 during operation. This camming contact will be described in further detail below. In some embodiments, body 64 also includes an abutment end extension 82 which extends the planar surface 67 longitudinally. The mechanical linkage 86 and the handle 18 move as a single unit. The mechanical linkage 86 supports the handle within the housing 12. The handle 18 may sit in an arcuate recess 70 of the top plate 14 which may guide handle along a path of motion as it moves within the housing 12 (see FIGS. 5-9).

In the present embodiment, the abutment end 66 of the handle 18 has a lateral width W2. The magnitude of width W2 is less than the magnitude of opening 44 width W1. As a result, the abutment end is able to pass through the opening 44.

In some embodiments, the mechanical linkage 86 is connected to a movable contact group (not shown), for actuating the movable contact group between a disengaged position and an engaged position relative a stationary contact group (not shown). In the disengaged position, the movable contact group is separated from the stationary contact group such that an electrical circuit is open and an electric current cannot flow therebetween. In the engaged position, the movable contact group contacts the stationary contact group such that the circuit is closed and an electric current can flow therebetween. The disengaged position of the movable contact group corresponds to the disengaged position of the handle 18, and the engaged position of the movable contact group corresponds to the engaged position of the handle 18. In some embodiments, the circuit breaker 10 may be a multi-pole circuit breaker, which may include multiple corresponding movable contact groups and stationary contact groups. For example, a two-pole circuit breaker may have a first moveable contact group positioned to be engageable with a first stationary contact group as described above, and a second movable contact group positioned to be engageable with a second stationary contact group. In another example, a three-pole circuit breaker may have first, second and third movable contact groups, with each group engageable with corresponding first, second, and third stationary contact groups in the manner described above. Each movable contact group may have an individual handle, or one handle may collectively actuate mechanical linkages for each of the movable contact groups. In some embodiments, the mechanical linkage 86 is a yoke, as shown in FIGS. 4-9.

Referring now to FIG. 4, a sectional view of the circuit breaker 10 is shown. As discussed in relation to FIG. 1, the lockout tab 20 is positioned in the second slot 17 of the top plate 14. The lockout tab 20 is further positioned within a channel 88 formed in a sidewall 90 of the housing 12 (see FIG. 5). The channel 88 extends from a base of the second slot 17 to a distal end 96 separated a longitudinal distance from the second slot 17. An outer periphery of the second section 36 of the lockout tab 20 is movable (e.g. slideable) along the length of channel 88 and partially through the second slot 17. A stop 94 is formed in the sidewall 90 and is positioned opposite the second slot 17 at the distal end 96 of channel 88. When the lockout tab 20 abuts the stop 94, the lockout tab is in the retracted position and is no longer moveable in the direction of the stop 94. The stop 94 is positioned such that only the first end 30 and recessed groove 42 protrude from the housing section 15 while the lockout tab 20 is in the retracted position. It should be understood that a corresponding channel is positioned on an opposite sidewall of the housing 12, but is not shown due to the orientation of the sectional view.

When the lockout tab 20 is in the extended position, the receiver opening 40 is aligned with notch 19. Additionally, the detents 58 frictionally contact a surface of the second slot 17 to form a force fit that prevents the tab from undesirably repositioning in the second slot 17 as a result of minor vibration or impacts to the circuit breaker (e.g. vibrations resulting from proximate power tools). The detents 58 contact the top plate 14 as the lockout tab 20 is moved between the retracted position and the extended position. The resulting friction fit between the detents and slot wall reduces the likelihood that the lockout tab 20 will unintentionally reposition between the retracted position and the extracted position and/or vice versa.

When the lockout tab 20 is moved beyond the extended position, the shoulders 38 abut the top plate 14 such that the lockout tab 20 cannot be removed from the circuit breaker 10. Therefore, the lockout tab 20 may be captive and integral to the circuit breaker 10 while the top plate 14 is installed.

The handle 18 is positioned within the circuit breaker 10 such that the grip 78 protrudes from the top plate 14 and slot 13. The handle 18 is movable between the engaged position and the disengaged position, along the channels previously described. In the disengaged position, grip 78 may be positioned away from the lockout tab. See FIG. 5. When the handle is in the engaged position the grip is moved proximate the lockout tab 20 See FIG. 6. A conventional mechanical linkage or actuator (e.g. mechanical linkage 86) enables the movement of the handle and grip between the engaged and disengaged positions. Moving the handle 18 between the engaged position and the disengaged position and/or vice versa also moves mechanical linkage/actuator. Movement of the handle 18 may be achieved by actuating the grip 78. Further details regarding the movement of the handle 18 will be described in relation to FIGS. 5-9 and the operation of circuit breaker 10.

FIGS. 5-9 illustrate the operation of the lockout tab 20 of circuit breaker 10. Referring now to FIG. 5, a state 500 of circuit breaker 10 is shown. In state 500, the handle 18 is in the disengaged position and the lockout tab 20 is in the extended position without a locking member 200 inserted in the lockout member receiver opening 40. The movable contacts are not in contact with the stationary contacts, and as a result the circuit is open, thereby prohibiting the flow of electric current. State 500 is achievable when the circuit breaker is switched off and the lockout tab 20 is moved to the extended position.

Referring now to FIG. 6, a state 510 of circuit breaker 10 is shown. In state 510, handle 18 is shown displaced along the path of motion with the grip 78 located between the engaged position and disengaged position. The lockout device 200 is not inserted in the lockout member receiver opening 40. As shown in FIG. 6, in state 510, the surface 67 of abutment end 66 of the handle 18 abuts the abutment surface 46 of lockout tab 20. The contact, referred to as camming contact, urges the lockout tab 20 from the extended position to the retracted position and inward within slot 17. Further camming contact between surface 67 and abutment surface 46 urges on the lockout tab 20 to be displaced along the channels 88 toward the retracted position.

Referring now to FIG. 7, a state 520 of circuit breaker 10 is shown. In state 520, handle 18 is in the engaged position and the lockout tab 20 is in the retracted position. As the handle is moved between state 510 and state 520, surface 67 further cams against abutment surface 46. The lockout tab 20 slides toward the retracted position as a result. Eventually, the rotating motion of handle 18 and the linear motion of lockout tab 20 will result in surface 67 sliding past abutment surface 46 as the abutment end 66 of the handle 18 passes through handle opening 44, at which point the extension 82 contacts the abutment surface 46. The extension 82 will cam relative the abutment surface 46 in the same manner that surface 67 cams with the abutment surface. Eventually, lockout tab 20 contacts stop 94 shown in FIG. 5, which impedes the sliding motion of the lockout tab into second slot 17 and the handle 18 moves to the engaged position. In the resulting state 520, the movable contacts are in contact with the stationary contacts, and as a result the circuit is closed. The circuit breaker is switched on and electric current is able to flow.

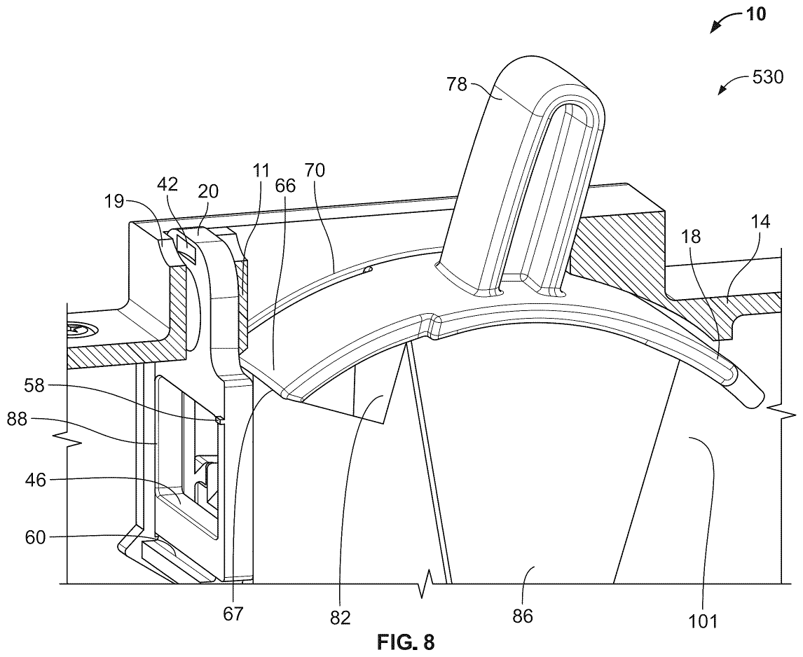

Referring now to FIG. 8, a state 530 of the circuit breaker 10 is shown. In state 530, handle 18 is in the disengaged position and the lockout tab 20 is in the retracted position. State 530 may result from switching off or tripping the circuit breaker 10, after the circuit breaker 10 was activated in state 520. Notably, the movement of handle 18 when switching off or tripping circuit breaker 10 is not coupled to the movement of lockout tab 20. The movement illustrated in states 510 and 520 is a result of the contact between lockout tab 20 and handle 18. While the circuit breaker is in state 530, the movable contacts are not in contact with the stationary contacts, and as a result the circuit is open, thereby prohibiting the flow of electric current. Transitioning from state 530 to state 500 is accomplished when the operator moves the lockout tab 20 from the retracted position to the extended position (e.g. by grabbing and pulling up on the lockout tab 20 via groove 42). Transitioning from state 530 to state 500 is easily accomplished due to the integral nature of the lockout tab 20. Typically, no additional tools or installation processes are required to reposition the lockout tab 20 to the extended position.

Referring now to FIG. 9, a state 540 of the circuit breaker 10 is shown. In state 540, the handle 18 is positioned along the path of motion between the disengaged position and the engaged position. A locking member 200 is inserted through the receiver opening 40. As the handle 18 contacts the lockout tab 20 and begins to cause it to slide along channels 88, as described above, the locking member 200 will contact the notch 19. As a result, the sliding motion of lockout tab 20 is impeded such that it cannot reach the retracted position. Correspondingly, the abutment surface 46 impedes the motion of handle 18 such that it cannot reach the engaged position, thus preventing the movable contacts from contacting the stationary contacts. Therefore, the presence of the locking member 200 in state 540 during the operation of the circuit breaker 10 results in a lockout of the circuit breaker 10. In other words, the locking member 200 as shown in FIG. 9 makes it nearly impossible to close the circuit without removing the locking member 200. Such an operational feature may be desirable when performing maintenance on the circuit, for example.

In some embodiments, the circuit breaker 10 may be a multi-pole circuit breaker. As described above, the multi-pole circuit breaker may have one or multiple handles. In a multi-pole circuit breaker 10 with one handle, a single lockout tab 20 may be used to restrict the movement of each of the movable contact groups. In a multi-pole circuit breaker 10 with multiple linked handles, a single lockout tab 20 may be desirable to collectively restrict the linked handles. Alternatively, multiple lockout tabs 20 may be desirable to individually restrict each handle, and therefore each contact group.

In some embodiments, the lockout tab may be positioned proximate the rounded end 68 of handle 18. Inserting the locking member 200 through the receiver opening 40 similarly restricts the movement of lockout tab 20, but the inverse positioning instead impedes the movement of the handle 18 from the engaged position to the disengaged position. Therefore, the locking member 200 makes it nearly impossible to open the circuit and stop the flow of electric current. Such an embodiment may be desirable in an electrical circuit for a building sprinkler system, or any other circuit in which the uninterrupted flow of electricity is desirable for safety.

In some embodiments, the lockout tab 20 is installed in the housing 12 and positioned in the channels 88 prior to the top plate 14 being installed. In some embodiments, the lockout tab 20 may be installed in a previously assembled circuit breaker 10 by removing the top plate 14 and installing the lockout tab 20 in the channels 88 prior to replacing the top plate 14.

Generally, the present disclosure relates to a circuit breaker with a lockout tab which is integral to the circuit breaker. The present disclosure further relates to operating the circuit breaker. The circuit breaker is operable between a switched on state and a switched off state using a handle to actuate at least one movable contact group. The lockout tab and an external locking member may be used to restrict the circuit breaker to the switched off state such that a circuit connected through the circuit breaker cannot be closed. Such a state may be desirable when diagnosing a problem, performing maintenance, or other scenarios.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

As used herein, the term “approximately” refers to a measurable value such as a parameter, an amount, a temporal duration, and the like and is meant to include variations of the measurable quantity between +/−15% and +/−0.1% or less of and from the particularly recited value, in so far as such variations are appropriate to perform in the one or more embodiments of the disclosure described herein. Furthermore, it is also to be understood that the value to which the modifier “approximately” refers is itself specifically disclosed herein.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

All methods described herein can be performed in any suitable order unless otherwise indicated herein or otherwise clearly contradicted by context. The use of any and all examples, or exemplary language (e.g., “such as”), is intended merely to better illustrate the present disclosure and does not pose a limitation on the scope of the present disclosure or any embodiments unless otherwise claimed.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A circuit breaker comprising:
a housing;
a handle, wherein the handle is movable between a first position and a second position; and
a lockout tab integral with the circuit breaker and supported by the housing, the lockout tab moveable between a retracted position and an extended position, the lockout tab comprising:
a body comprising a first end and a second end, and a receiver opening formed in the body proximate the first end and configured to receive a device for impeding the movement of the tab to the retracted position, wherein the first end is located outside the housing and the second end is located inside the housing, the body further comprising an abutment surface formed in the body located proximate the second end and in a path of motion of the handle between the first position and the second position,
wherein when the handle is moved into abutment with the abutment surface the lockout tab may be pushed to the retracted position by the handle, and
wherein when the handle is moved into abutment with the abutment surface and a motion impeding device is installed, movement of the tab to the retracted position is impeded and movement of the handle to the second position is impeded.

2. The circuit breaker of claim 1, wherein the body of the lockout tab further comprises a slot configured to aid in repositioning the lockout tab between the retracted position to the extended position.

3. The circuit breaker of claim 2, wherein the groove is positioned between the first end and the receiver opening.

4. The circuit breaker of claim 1, wherein the body of the lockout tab is configured to be slideable along respective channels formed in the housing to enable the movement of the lockout tab between the extended position and the retracted position.

5. The circuit breaker of claim 1, wherein the lockout tab further comprises a handle opening disposed through the body proximate the abutment surface.

6. The circuit breaker of claim 5, wherein the handle opening is configured to allow the handle to slide partially therethrough.

7. The circuit breaker of claim 5, wherein the handle opening is substantially rectangular.

8. The circuit breaker of claim 1, wherein the body of the lockout tab further comprises shoulders which impede the removal of the lockout tab from the housing when the lockout tab is in the extended position.

9. The circuit breaker of claim 4, wherein the lockout tab further comprises at least one detent protruding from the body.

10. The circuit breaker of claim 1, wherein the lockout tab body comprises a first section and a second section, the second end being located at the second section and the first end being located at the first section, the magnitude of the lateral width of the first section being less than the magnitude of the lateral width of the second section.

11. The circuit breaker of claim 10, wherein the second section comprises a handle opening, the handle opening being defined by an upper surface, the abutment surface and longitudinal surfaces extending between the upper and abutment surfaces, the abutment surface proximate the second end.

12. The circuit breaker of claim 1 further comprising a top plate, the top plate comprising an arcuate groove, the arcuate groove being located proximate the receiver opening when the lockout tab is in the extended position.

13. A circuit breaker comprising:
a housing defining a housing chamber;
a handle configured to be located partially within the housing, wherein the handle comprises a body with a first end, and wherein the handle body is moveable within the housing chamber; and
a lockout tab comprising a lockout tab body movable within the housing between a retracted position and an extended position, the lockout tab comprising an abutment surface, wherein the lockout tab is moved to the retracted position when the first end of the handle body is moved into abutment with the abutment surface.

14. The circuit breaker of claim 13, wherein lockout tab comprises a handle opening, the abutment surface defining a portion of the handle opening, the first end of the handle body configured to be movable through the handle opening.

15. The circuit breaker of claim 13, wherein the lockout tab body comprises a first section, and a second section, a receiver opening being located in the first section, a handle opening being located in the second section.

16. The circuit breaker of claim 15, wherein the receiver opening is configured to receive a circuit breaker locking member.

17. A method of locking a circuit breaker, wherein the circuit breaker comprises a housing;
a handle partially enclosed within the housing, the handle movable between a first position and a second position; and an integral lockout tab positioned partially within the housing, the lockout tab comprising an abutment surface positioned in a path of motion of the handle; wherein the method comprises:
extracting, from a housing of the circuit breaker, the lockout tab, wherein the lockout tab comprises a body with a receiver opening; and
inserting a locking member through the receiver opening.

18. The method of claim 17, further comprising moving, toward the second position, the handle, such that an end of the handle contacts the abutment surface, wherein the locking member impedes movement of the lockout tab.

19. The method of claim 17 further comprising removing the locking member and moving the handle so that an end of the handle contacts the abutment surface, thereby causing the lockout tab to move inwardly such that the handle reaches the second position, and the lockout tab moves to the retracted position.
